(19) United States
(12) Patent Application Publication
(10) Pub. No.: US 2025/0278080 A1
(43) Pub. Date: Sep. 4, 2025

(54) QUALITY PREDICTION MODEL CREATION SYSTEM, QUALITY PREDICTION SYSTEM, QUALITY PREDICTION MODEL CREATION METHOD, AND QUALITY PREDICTION METHOD

(71) Applicant: Proterial, Ltd., Tokyo (JP)

(72) Inventors: Sohei KODAMA, Tokyo (JP); Masaharu TOYA, Tokyo (JP); Ryosuke KUDO, Tokyo (JP)

(21) Appl. No.: 19/040,076

(22) Filed: Jan. 29, 2025

(30) Foreign Application Priority Data
Feb. 29, 2024 (JP) 2024-030763

(51) Int. Cl. G05B 19/418

(52) U.S. Cl. CPC G05B 19/41875; G05B 19/41885

(57) ABSTRACT

A quality prediction model for predicting quality of an elongated product is created. A quality prediction model creation system includes: a first logging data acquisition unit acquiring already-known first logging data respectively detected at every predetermined interval by a plurality of detectors and stored at time of manufacture of an elongated product; an average value calculation unit calculating each average value of the logging data from the logging data acquired by the first logging data acquisition unit; and a model creation unit creating a quality prediction model corresponded to quality property of the elongated product, based on the average value of the logging data.

### CROSS-REFERENCE TO RELATED APPLICATION

This application claims foreign priority benefits under 35 U.S.C. § 119 to Japanese Patent Application No. 2024-30763 filed on Feb. 29, 2024, the content of which is hereby incorporated by reference in its entirety.

### TECHNICAL FIELD OF THE INVENTION

The present invention relates to a quality prediction model creation system, a quality prediction system, a quality prediction model creation method, and a quality prediction method.

### BACKGROUND OF THE INVENTION

Japanese Patent Application Laid-Open Publication No. 2022-87429 (Patent Document 1) describes a technique for accurately estimating a physical property value of a composite material by using artificial intelligence.

### SUMMARY OF THE INVENTION

In an elongated product, even if it is possible to evaluate a quality property of its end portion by a destructive test or the like, it is impossible to evaluate its quality property of its entire length. Accordingly, it is impossible to determine whether or not a quality property of an intermediate portion of the elongated product or the like actually satisfies a quality property to be required. And, the quality properties of the elongated product include quality properties, an actually-measured value of which is difficult to be logged during manufacture by a detector or the like, as different from physical property values such as an outer diameter, an eccentricity ratio, and an electrostatic capacitance.

A quality prediction model creation system according to an embodiment includes: a first logging data acquisition unit acquiring already-known first logging data respectively detected at every predetermined interval by a plurality of detectors and stored at time of manufacture of an elongated product; an average value calculation unit calculating each average value of the first logging data from the first logging data acquired by the first logging data acquisition unit; and a model creation unit creating a quality prediction model corresponded to quality property of the elongated product, based on the average value of the first logging data.

A quality prediction system according to an embodiment includes: a quality prediction model storage unit storing a quality prediction model created based on an average value of already-known first logging data of an elongated product and corresponded to quality property of the elongated product; a second logging data acquisition unit acquiring second logging data during manufacture of the elongated product at time of manufacture of an elongated product as a prediction target; and a prediction unit predicting quality property of the elongated product as the prediction target by substituting the second logging data acquired by the second logging data acquisition unit into the quality prediction model.

A quality prediction model creation method according to an embodiment includes: a step of acquiring already-known first logging data; a step of calculating each average value of the first logging data from the acquired first logging data; and a step of creating a quality prediction model corresponded to quality property of the elongated product, based on the average value of the first logging data.

A quality predicting method according to an embodiment includes: a step of acquiring already-known first logging data respectively detected at every predetermined interval by a plurality of detectors and stored at time of manufacture of an elongated product; a step of calculating each average value of the first logging data from the acquired first logging data; a step of creating a quality prediction model corresponded to quality property of the elongated product, based on the average value of the first logging data; a step of acquiring second logging data during manufacture of an elongated product as a prediction target; and a step of predicting quality property of the elongated product as the prediction target by substituting the second logging data into the quality prediction model.

According to an embodiment, a quality prediction model for predicting a quality of an elongated product can be created. According to an embodiment, quality property of an elongated product can be predicted over its entire length by using the quality prediction model.

### BRIEF DESCRIPTIONS OF THE DRAWINGS

FIG. 1 is a schematic diagram illustrating an example of a configuration of a manufacturing system including a quality prediction system;

FIG. 2 is a schematic diagram illustrating an example of a configuration of the manufacturing system including the quality prediction system;

FIG. 3 is a diagram illustrating an example of a hardware configuration of the quality prediction system;

FIG. 4 is a diagram illustrating an example of a functional block of the quality prediction system;

FIG. 5 is a flowchart illustrating an example of quality prediction model creation processing;

FIG. 6 is a diagram illustrating an example of first logging data;

FIG. 7 is a diagram illustrating an example of calculation result data representing a calculation result of an average value of logging data;

FIG. 8 is a flowchart illustrating an example of processing for achieving an entire length quality prediction technique;

FIG. 9 is a diagram for describing the entire length quality prediction technique;

FIG. 10 is a diagram illustrating an example of second logging data;

FIG. 11 is a diagram for describing an outline of a simulation;

FIG. 12 is a diagram illustrating a relationship between a measured value (measured strength) and a predicted value (predicted strength) of a tensile strength;

FIG. 13 is a diagram illustrating a relationship between a measured value (measured elongation) and a predicted value (predicted elongation) of a tensile elongation;

FIG. 14 is a diagram illustrating a number of screw revolutions and a cylinder temperature as second logging data;

FIG. 15 is a diagram illustrating a current value of a cylinder and a resin pressure value detected by a resin pressure sensor as second logging data;

FIG. 16 is a diagram illustrating a winding speed of a winder and an ambient air temperature as second logging data;

FIG. 17 is a diagram illustrating a maximum resin pressure and a driving force as second simulation data;

FIG. 18 is a diagram illustrating a retention time period and an average temperature as second simulation data;

FIG. 19 is a diagram illustrating a strain and a torque as second simulation data;

FIG. 20 is a diagram illustrating a prediction result of a tensile strength of a heat-resistant insulated electric wire; and

FIG. 21 is a diagram illustrating a prediction result of a tensile elongation of the heat-resistant insulated electric wire.

### DESCRIPTIONS OF THE PREFERRED EMBODIMENTS

The same components are denoted by the same reference symbols throughout all the drawings for describing the embodiments, and the repetitive description thereof will be omitted. Note that hatching is used even in a plan view so as to make the drawings easy to see.

The technical idea of the present embodiment is an idea of creating a quality prediction model and predicting quality property over an entire length of an elongated product by using the quality prediction model. If the elongated product is, for example, an electric wire covered with a heat-resistant insulating member, quality properties such as a tensile strength and a tensile elongation at each position of the electric wire are predicted by using CAE and AI/machine learning.

A technique according to the present embodiment creates a quality prediction model corresponded to quality property by machine learning, by using data (such as a number of screw revolutions of an extruder, a cylinder temperature, a resin pressure value, and an outer diameter size) that can be measured and logged at the time of manufacture of an elongated product in past and data (such as an average resin temperature in a cylinder, a maximum resin pressure value, a torque value, a strain magnitude) that can be calculated by a numerical simulation. The technique according to the present embodiment achieves prediction of quality property of the entire length of the elongated product by using a created quality prediction model and real-time data at the time of manufacture.

### Description of Related Art

A case of an elongated product such as a heat-resistant insulated electric wire will be described. Standards have been determined for quality properties of the heat-resistant insulated electric wire, such as an insulation resistance, a withstand voltage, tension of an insulator and a sheath, heating, an oil resistance, and the like, and a testing method for them has also be specifically determined by a rubber/plastic insulated electric wire testing method defined in JIS C3005.

Measurement for mechanical properties (a tensile strength and a tensile elongation) of an insulator and a sheath of an elongated cable such as a rubber electric wire is determined so that three or more dumbbell-shaped or tubular-shaped test pieces are sampled from a finished product and are measured at a predetermined tensile speed (25 to 500 mm/min), as described in 4.16 in JIS C3005. Accordingly, three or more test pieces are cut off from an end portion of the finished elongated cable, and a value of the tensile strength and a value of the tensile elongation are calculated by using a tensile tester, and are set as the quality properties of the elongated cable.

The related art is possible to evaluate the quality properties only by the destructive test for an end portion of the elongated product, and is impossible to determine whether or not an intermediate portion of the elongated product really satisfies the standards. There are also quality properties, the measured value of which in the elongated product during manufacture is difficult to be always logged by a detector or the like, as different from an outer diameter, an eccentricity ratio, an electrostatic capacitance, and the like.

### Configuration of Manufacturing System

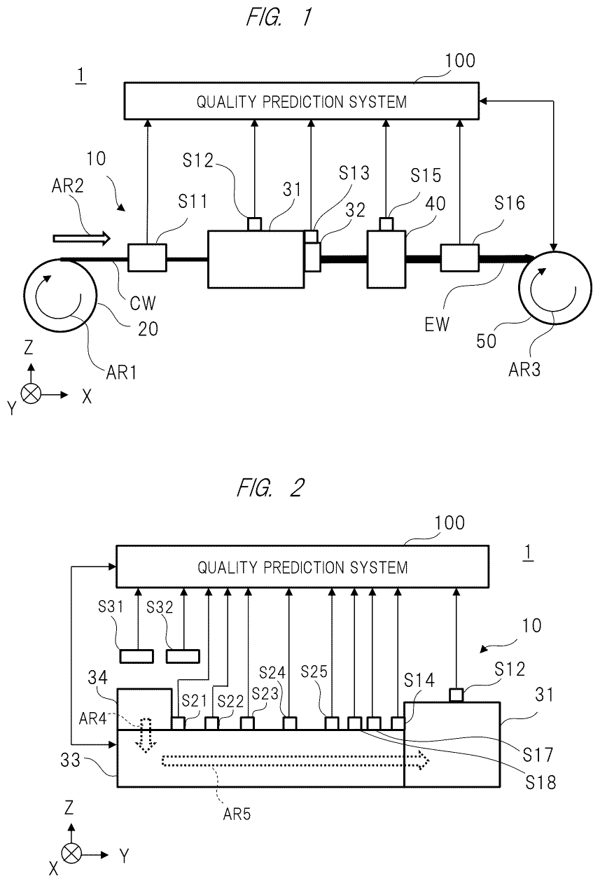

FIGS. 1 and 2 are schematic diagrams each illustrating an example of a configuration of a manufacturing system 1 including a quality prediction system 100. FIG. 1 is a schematic diagram illustrating an example of a configuration of an extruder 10 in the manufacturing system 1 viewed in a Y-direction. FIG. 2 is a schematic diagram illustrating an example of the configuration of the extruder 10 in the manufacturing system 1 viewed in an X-direction in a head 31 illustrated in FIG. 1. In the present embodiment, a case where the quality prediction system 100 includes a quality prediction model creation system will be described. However, the quality prediction system 100 and the quality prediction model creation system may be different systems from each other.

As illustrated in FIGS. 1 and 2, the X-direction, the Y-direction, and a Z-direction are defined. The X-direction, the Y-direction, and the Z-direction are perpendicular to one another, but may intersect one another at an angle other than the perpendicular angle.

The manufacturing system 1 includes the extruder 10 and the quality prediction system 100. The extruder 10 has a single screw not illustrated. In the present embodiment, a case where the quality property of a heat-resistant insulated electric wire EW manufactured as an example of the elongated product in the extruder 10 is predicted will be described. Note that the elongated product is not limited to an electric wire such as the heat-resistant insulated electric wire EW. The elongated product may be, for example, a pipe, a sheet, or a film. The quality prediction system 100 is, for example, a computer system. Details of the quality prediction system 100 will be described later.

As illustrated in FIG. 1, the extruder 10 manufacture the heat-resistant insulated electric wire EW by covering a core wire CW with resin such as a heat-resistant insulating member. As illustrated in FIG. 1, the extruder 10 includes a feeder 20, the head 31, a die 32, a water reservoir 40, and a winder 50. An extrusion line is made of the feeder 20, the head 31, the die 32, the water reservoir 40, and the winder 50. As illustrated in FIG. 2, the extruder 10 includes a cylinder 33 connected to the head 31 and a material input unit 34.

The feeder 20 is housed in a state with the wound core wire CW thereon. When the feeder 20 rotates as illustrated with an arrow AR1, the core wire CW is drawn from the feeder 20. The core wire CW drawn in a direction illustrated with an arrow AR2 passes through the head 31 and the die 32. The heat-resistant insulated electric wire EW that has passed through the head 31 and the die 32 passes through the water reservoir 40, and then, is wound up by the winder 50. In the winder 50, the heat-resistant insulated electric wire EW is wound thereon, and is housed therein. An illustrated arrow AR3 indicates a direction in which the heat-resistant insulated electric wire EW is wound.

The head 31 is connected to the cylinder 33. The heat-resistant insulating member is supplied from the cylinder 33 to the head 31. The heat-resistant insulating member supplied to the head 31 adheres to the core wire CW drawn from the feeder 20. The die 32 is provided with a hole of a predetermined size although not illustrated. The core wire CW to which the heat-resistant insulating member has adhered passes through the hole of the die 32. As a result, the heat-resistant insulating member having a thickness corresponding to the size of the hole is formed on the core wire CW, to manufacture the heat-resistant insulated electric wire EW.

The heat-resistant insulated electric wire EW that has passed through the die 32 passes through the water reservoir 40. In the water reservoir 40, the heat-resistant insulated electric wire EW is cooled to a predetermined temperature. The heat-resistant insulated electric wire EW cooled as described above is wound by the winder 50. In the winder 50, the heat-resistant insulated electric wire EW is wound at a winding speed (hereinafter, also referred to as a “linear speed”), and is housed in the winder 50. Information representing the winding speed and a winding current value representing a current value to be supplied to the winder 50 is transmitted to the quality prediction system 100 at every predetermined interval such as one second.

As illustrated in FIG. 2, the head 31 is connected to one end of the cylinder 33, and the material input unit 34 is connected to the top of the other end thereof. The heat-resistant insulating member is inputted into the material input unit 34. As illustrated with a dashed arrow AR4, the heat-resistant insulating member is supplied from the material input unit 34 into the cylinder 33. The cylinder 33 has a single screw. The cylinder 33 is configured to rotate the screw at a predetermined number of revolutions, depending on a current amount to be supplied. By the rotation of the screw, the heat-resistant insulating member inputted from the material input unit 34 is gradually extruded toward the head 31 side as illustrated with a dashed arrow AR5. The extruded heat-resistant insulating member is adhered to the core wire CW in the head 31, and is extruded outward as part of the heat-resistant insulated electric wire EW from the die 32. The number-of-revolutions information representing the number of revolutions of the screw, an acceleration, a current value, and the like are transmitted to the quality prediction system 100 at every predetermined interval such as one second.

Here, the screw has, for example, three playing roles. The first role is a role of extruding the heat-resistant insulating member supplied from the material input unit 34 toward the head 31 side to reach the head 31. At this time, residual heat is given to the heat-resistant insulating member. The second role is a role of bringing the heat-resistant insulating member from a solid state to a molten state. The third role is a role of stably extruding a certain amount of the heat-resistant insulating member from the die 32.

A core wire temperature sensor S11 as one of detectors is provided between the feeder 20 and the head 31. The core wire temperature sensor S11 detects a temperature of the core wire CW between the feeder 20 and the head 31. The temperature detected by the core wire temperature sensor S11 is transmitted to the quality prediction system 100 at every predetermined interval such as one second.

As illustrated in FIG. 1, the head 31 is provided with a head temperature sensor S12 and a die temperature sensor S13. The head temperature sensor S12 and the die temperature sensor S13 are respectively detectors. The head temperature sensor S12 is a sensor that detects a head temperature of the head 31. The die temperature sensor S13 is a sensor that detects a die temperature of the die 32. A neck temperature sensor S14 as one of detectors is provided in the vicinity of a junction between the cylinder 33 and the head 31 (see FIG. 2). The neck temperature sensor S14 is a sensor that detects a neck temperature in the vicinity of the junction between the cylinder 33 and the head 31. The head temperature, the die temperature, and the neck temperature respectively detected by the head temperature sensor S12, the die temperature sensor S13, and the neck temperature sensor S14 are each transmitted to the quality prediction system 100 at every predetermined interval such as one second.

The water reservoir 40 is provided with a water reservoir temperature sensor S15 as one of detectors. The water reservoir temperature sensor S15 is a sensor that detects a water temperature of the water reservoir 40. The temperature detected by the water reservoir temperature sensor S15 is transmitted to the quality prediction system 100 at every predetermined interval such as one second.

An outer diameter measurement sensor S16 as one of detectors is provided between the water reservoir 40 and the feeder 50. The outer diameter measurement sensor S16 is a sensor that detects an outer diameter size of the heat-resistant insulated electric wire EW that has been cooled by the water reservoir 40. The outer diameter size detected by the outer diameter measurement sensor S16 is transmitted to the quality prediction system 100 at every predetermined interval such as one second.

As illustrated in FIG. 2, a resin temperature sensor S17 and a resin pressure sensor S18 are provided in the vicinity of a connection of the cylinder 33 with the head 31. The resin temperature sensor S17 and the resin pressure sensor S18 are respectively detectors. The resin temperature sensor S17 is a sensor that detects a resin temperature of the heat-resistant insulating member to be supplied to the head 31. The resin pressure sensor S18 is a sensor that detects a resin pressure value (also referred to as a distal-end resin pressure value) of the heat-resistant insulating member to be supplied to the head 31. The resin temperature and the resin pressure value respectively detected by the resin temperature sensor S17 and the resin pressure sensor S18 are each transmitted to the quality prediction system 100 at every predetermined interval such as one second.

The cylinder 33 is provided with five temperature sensors S21 to S25 in a longitudinal direction from the material input unit 34 side. The five temperature sensors S21 to S25 are respectively detectors. As a result, a temperature of the cylinder 33 is detected at a plurality of positions in the longitudinal direction of the cylinder 33. Note that the number of temperature sensors is not limited to five, but may be, for example, three, four, six or more. Temperatures respectively detected by the five temperature sensors S21 to S25 are each transmitted to the quality prediction system 100 at every predetermined interval such as one second. Although the cylinder 33 has three playing roles as described above, since the plurality of temperature sensors S21 to S25 are provided, the quality prediction system 100 can detect a change in the temperature of the cylinder 33 in each of the playing roles.

An air temperature sensor S31 and a humidity sensor S32 are arranged around the extruder 10, e.g., around the cylinder 33. The air temperature sensor S31 and the humidity sensor S32 are respectively detectors. A temperature detected by the air temperature sensor S31 and a humidity detected by the humidity sensor S32 are each transmitted to the quality prediction system 100 at every predetermined interval such as one second.

### Hardware Configuration

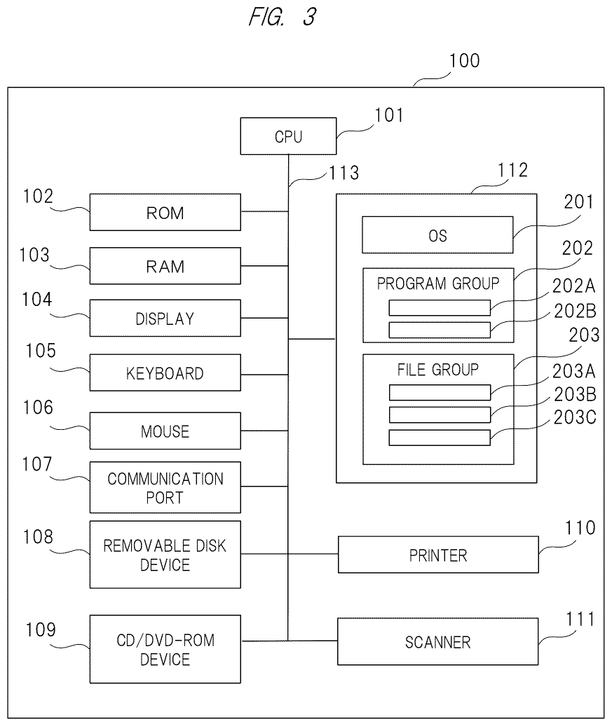

Next, a hardware configuration of the quality prediction system 100 according to the present embodiment will be described. FIG. 3 is a diagram illustrating an example of the hardware configuration of the quality prediction system 100 according to the present embodiment. The configuration illustrated in FIG. 3 is merely the example of the hardware configuration of the quality prediction system 100. The hardware configuration of the quality prediction system 100 is not limited to the configuration illustrated in FIG. 1, but may be another configuration.

In FIG. 1, the quality prediction system 100 includes a CPU (central Processing Unit) 101 that executes programs. The CPU 101 is electrically connected to, for example, a ROM (Read Only Memory) 102, a RAM (Random Access Memory) 103, and a hard disk device 112 via a bus 113, and is configured to control these hardware devices.

The CPU 101 is also connected to an input device and an output device via the bus 113. Examples of the input device can include a keyboard 105, a mouse 106, a communication port 107, and a scanner 111. On the other hand, examples of the output devices can include a display 104, the communication port 107, and a printer 110. Further, the CPU 101 may be connected to, for example, a removable disk device 108 or a CD/DVD-ROM device 109. And, for example, the cylinder 33, the feeder 20, the winder 50, the core wire temperature sensor S11, the head temperature sensor S12, the die temperature sensor S13, the neck temperature sensor S14, the water reservoir temperature sensor S15, the outer diameter measurement sensor S16, the resin temperature sensor S17, the resin pressure sensor S18, the temperature sensors S21 to S25, the air temperature sensor S31, and the humidity sensor S32 are connected to the communication port 107.

The quality prediction system 100 may be connected to, for example, a network. If, for example, the quality prediction system 100 is connected to another external device via the network, the communication port 107 constituting part of the quality prediction system 100 is connected to a LAN (local area network), a wide area network (WAN), or the Internet.

The RAM 103 is an example of a volatile memory while storage media such as the ROM 102, the removable disk device 108, the CD/DVD-ROM device 109, and the hard disk device 112 are each an example of a non-volatile memory. The volatile memory and the non-volatile memory configure a storage device of the quality prediction system 100.

The hard disk device 112 stores, for example, an operating system (OS) 201, a program group 202, and a file group 203. Programs included in the program group 202 are executed while the CPU 101 uses the operating system 201. The RAM 103 temporarily stores at least some of programs in the operating system 201 and application programs executed by the CPU 101, and stores various types of data required for processing executed by the CPU 101.

The ROM 102 stores a BIOS (Basic Input Output System) program, and the hard disk device 112 stores a boot program. When the quality prediction system 100 is activated, the BIOS program stored in the ROM 102 and the boot program stored in the hard disk device 112 are executed, and the operating system 201 is activated by the BIOS program and the boot program.

The program group 202 stores a program for achieving a function of the quality prediction system 100, and the program is loaded and executed by the CPU 101. The file group 203 stores information, data, a signal value, a variable value, and a parameter, which represent a result of the processing executed by the CPU 101, respectively, as factors of a file. The program group 202 includes, for example, a quality prediction model creation program 202A and a quality prediction program 202B described later.

The file group 203 includes logging data 203A, simulation data 203B, and a quality prediction model 203C. The logging data 203A is manufacturing data acquired when the heat-resistant insulated electric wire EW has been manufactured. The simulation data 203B is simulation data representing a result of a simulation using the logging data. The quality prediction model 203C is a model for predicting the quality property of the heat-resistant insulated electric wire EW. Details of the logging data 203A, the simulation data 203B, and the quality prediction model 203C will be described later.

The file is stored in a storage medium such as the hard disk device 112 or a memory. The information, data, signal value, variable value, and parameter stored in the storage medium such as the hard disk device 112 or the memory are loaded into a main memory or a cache memory by the CPU 101, and are used for an operation of the CPU 101, typified by extraction, search, reference, comparison, calculation, processing, editing, output, printing, and display. For example, during the above-described operation of the CPU 101, the information, data, signal value, variable value, and parameter are temporarily stored in a main memory, a register, a cache memory, a buffer memory, or the like.

The function of the quality prediction system 100 may be achieved by firmware stored in the ROM 102, or by only software, only hardware typified by an element, a device, a substrate, and a wiring, a combination of the software and the hardware, or further a combination with the firmware. The firmware and the software are stored as a program in a storage medium typified by the hard disk device 112, the removable disk drive 108, the CD/DVD-ROM drive 109, and the like. The program is loaded and executed by the CPU 101. For example, by the program, the computer is functioned as the quality prediction system 100.

Thus, the quality prediction system 100 is the computer including the CPU 101 as a processing device, the hard disk device 112 or the memory as a storage device, the keyboard 105, the mouse 106, or the communication port 107 as an input device, and the display 104, the printer 110, or the communication port 107 as an output device. The function of the quality prediction system 100 is achieved by using the processing device, the storage device, the input device, and the output device.

### Functional Block

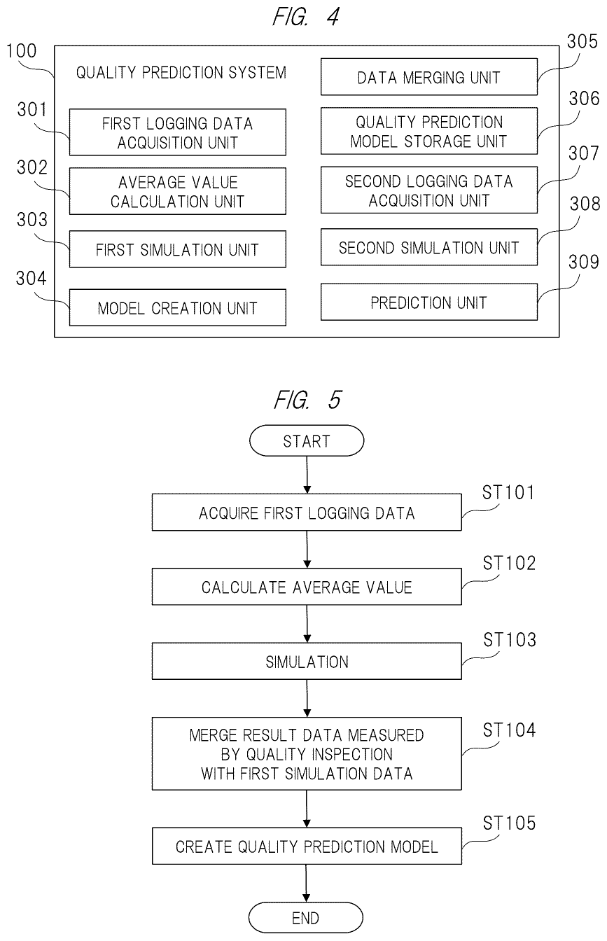

FIG. 4 is a diagram illustrating an example of a functional block of the quality prediction system 100. As illustrated in FIG. 4, the quality prediction system 100 includes a first logging data acquisition unit 301, an average value calculation unit 302, a first simulation unit 303, a model creation unit 304, a data merging unit 305, a quality prediction model storage unit 306, a second logging data acquisition unit 307, a second simulation unit 308, and a prediction unit 309. Details of functions respectively achieved by the first logging data acquisition unit 301, the average value calculation unit 302, the first simulation unit 303, the model creation unit 304, the data merging unit 305, the quality prediction model storage unit 306, the second logging data acquisition unit 307, the second simulation unit 308, and the prediction unit 309 will be described later.

### Creation of Quality Prediction Model

Next, a quality prediction model creation processing for creating the quality prediction model 203C for predicting the quality property of the heat-resistant insulated electric wire EW manufactured by the extruder 10 will be described. FIG. 5 is a flowchart illustrating an example of the quality prediction model creation processing. This processing is achieved when the quality prediction model creation program 202A stored in the hard disk device 112 is loaded and executed by the CPU 101.

First, the CPU 101 acquires the first logging data in step ST101. A function of the first logging data acquisition unit 301 in the quality prediction system 100 is achieved by processing in step ST101. From the hard disk device 112, the first logging data acquisition unit 301 acquires the already-known first logging data respectively detected and stored at every predetermined interval by a plurality of devices and sensors at the time of manufacture of the heat-resistant insulated electric wire EW. The acquired first logging data is, in other words, already-known manufacturing data for each production number of the same product at the time of manufacture of the heat-resistant insulated electric wire EW. Here, examples of the plurality of devices and sensors include the cylinder 33, the feeder 20, the winder 50, the core wire temperature sensor S11, the head temperature sensor S12, the die temperature sensor S13, the neck temperature sensor S14, the water reservoir temperature sensor S15, the outer diameter measurement sensor S16, the resin temperature sensor S17, the resin pressure sensor S18, the temperature sensors S21 to S25, the air temperature sensor S31, and the humidity sensor S32.

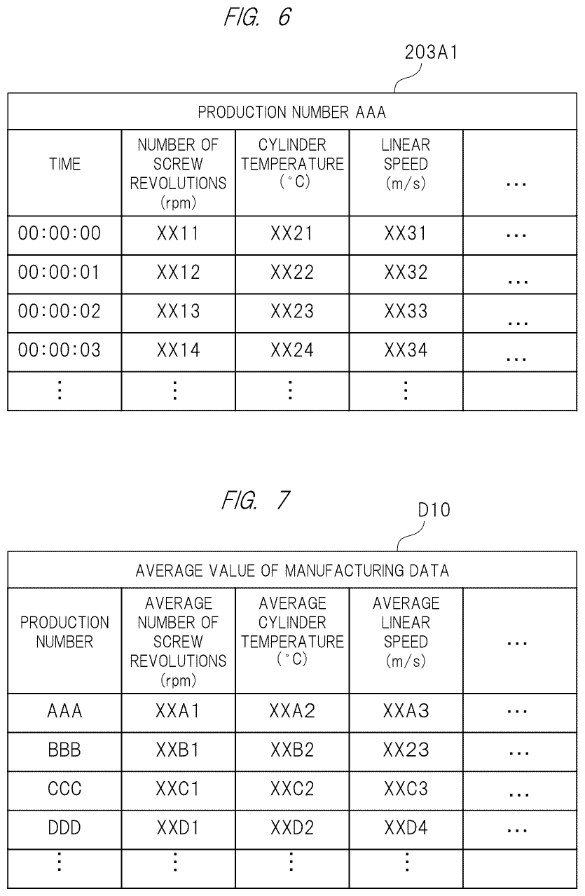

FIG. 6 is a diagram illustrating an example of first logging data 203A1. The first logging data 203A1 is data included in the logging data 203A. FIG. 6 illustrates the first logging data 203A1 for the heat-resistant insulated electric wire EW with a production number “AAA”. Factors such as a number of screw revolutions (rpm), a cylinder temperature (° C.), a linear speed (m/s), etc., are corresponded to a time. Although not illustrated, temperatures respectively acquired by the temperature sensors S21 to S25 are included as the factors in the cylinder temperature. In the present embodiment, the first logging data 203A1 is included and stored in the logging data 203A of the file group 203 at every one second as the predetermined interval. Accordingly, the first logging data 203A1 is acquired from the file group 203. The illustration shows an example in which the three factors are included as the first logging data 203A1. However, as the first logging data 203A1, the logging data as a predetermined factor among all logging data as the factors that can be acquired by the quality prediction system 100 is corresponded to the time.

In order to create the quality prediction model 203C, for example, the CPU 101 desirably acquires several tens or more of pieces of the already-known first logging data 203A1 for the same product. The more factors as the first logging data 203A1 to be acquired are desirable. The CPU 101 desirably acquires the logging data as the measurable factors such as the number of screw revolutions, the cylinder temperature, the linear speed, etc., illustrated in FIG. 6 among the factors acquired from the logging data 203A, as many as possible as the first logging data 203A1. The CPU 101 can set any of all the factors included in the logging data 203A to a creation target for the quality prediction model 203C, based on setting. The created quality prediction model 203C is stored in the hard disk device 112.

Next, the CPU 101 calculates an average value in step ST102. A function of the average value calculation unit 302 in the quality prediction system 100 is achieved by processing in step ST102. The average value calculation unit 302 calculates, for each of the factors, an average value of the first logging data 203A1 from the first logging data 203A1 acquired by the first logging data acquisition unit 301 in step ST101. In the present embodiment, if the logging data 203A includes data of a setup time period and an adjustment time period before manufacture of the heat-resistant insulated electric wire EW, the CPU 101 performs processing for excluding respective parts for the setup time period and the adjustment time period from the first logging data 203A1. As a result, the CPU 101 can acquire, for each of the factors, the average value of the first logging data 203A1 from the start to the end of manufacture of the heat-resistant insulated electric wire EW.

FIG. 7 is a diagram illustrating an example of calculation result data D10 representing a calculation result of the average value of the first logging data 203A1. As illustrated in FIG. 7, an average number of screw revolutions, an average cylinder temperature, an average linear speed, etc., for each production number are calculated.

Next, the CPU 101 performs a simulation in step ST103. A function of the first simulation unit 303 in the quality prediction system 100 is achieved by processing in step ST103. The first simulation unit 303 simulates the quality property of the heat-resistant insulated electric wire EW by using the average value of the first logging data 203A1. The CPU 101 calculates a feature amount described later by using the average value of the first logging data 203A1 calculated in step ST102 as a condition for a CAE (Computer Aided Engineering) analysis. The feature amount can also be said as the quality property of the heat-resistant insulated electric wire EW acquired by simulation data. The number of production numbers used in the CAE analysis is desirably larger in order to increase an accuracy of the correspondence to the quality property of the heat-resistant insulated electric wire EW. On the other hand, the larger number of production numbers possibly causes an enormous time period required for the CAE analysis. Accordingly, the number of production numbers is desirably set such that a computational load used for the CAE analysis does not exceed a limit of the CPU 101 along with the large number of production numbers. A simulation result in step ST103 is set as first simulation data. The first simulation data is stored as simulation data 203B in the hard disk device 112.

The above-described feature amount is, for example, the unmeasurable data such as the strain and the retention time period of the heat-resistant insulating member in the extruder 10, or data that requires a large amount of labor for the measurement. A cylinder temperature related to the cylinder 33, a temperature and a resin pressure value of the heat-resistant insulating member in the cylinder 33, and the like may be added to the feature amounts. These items can be actually measured, but are measured as only their values in the vicinity of the arranged detector. In other words, this is because positions and values of an “average” temperature, a “maximum” resin pressure, and the like of the heat-resistant insulating member in the extruder 10 can be derived by a simulation. Therefore, the CPU 101 also desirably sets, as the feature amount, the factor that can be detected as the value only in the vicinity of the detector, and adds the factor to the simulation target.

Next, the CPU 101 merges result data measured by a quality inspection with the first simulation data in step ST104. A function of the data merging unit 305 in the quality prediction system 100 is achieved by processing in step ST104. The data merging unit 305 acquires quality result data of a quality test performed for an end portion of the heat-resistant insulated electric wire EW, and merges the quality result data with the first simulation data. The quality inspection is, for example, a destructive inspection. The quality inspection targets are the factors that can be evaluated only by the destructive inspection, such as a tensile strength, a tensile elongation, a flame retardancy, and an oil resistance. If these factors include a factor that allows the validity of the first simulation data to be determined, the CPU 101 desirably simulates this factor, and merges the factor with the quality result data.

Next, the CPU 101 creates a quality prediction model 203C in step ST105. A function of the model creation unit 304 in the quality prediction system 100 is achieved by processing in step ST105. The model creation unit 304 creates the quality prediction model 203C corresponded to the quality property of the heat-resistant insulated electric wire EW, based on the average value of first logging data 203A1 and the first simulation data representing the simulation result. The model creation unit 304 creates the quality prediction model 203C by machine learning while setting the quality property data representing the quality property of the heat-resistant insulated electric wire EW, respectively, as objective variables, and setting the first logging data of the heat-resistant insulated electric wire EW and the first simulation data, respectively, as explanatory variables.

A multivariate analysis is used to create the quality prediction model 203C. There are many methods for performing the multivariate analysis. The CPU 101 can calculate a regression coefficient of each data relatively easily by performing the multiple regression analysis using a class “sklearn. Linear model. Linear Regression” of a python machine learning library “scikit-learn” given as an example. The CPU 101 may interpret the quality prediction model 203C by using libraries such as “SHAP”, acquire a degree of contribution or the like, and exactly examine whether or not the quality prediction model 203C is valid. The machine learning is used as described above to create the quality prediction model 203C. The quality prediction model 203C created as described above is stored in the hard disk device 112 by a function of the quality prediction model storage unit 306.

### Prediction of Entire Length Quality

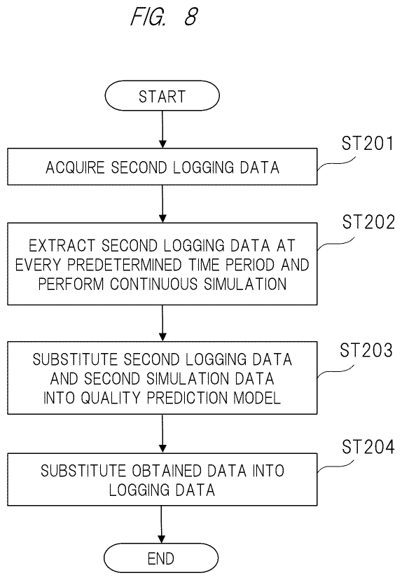

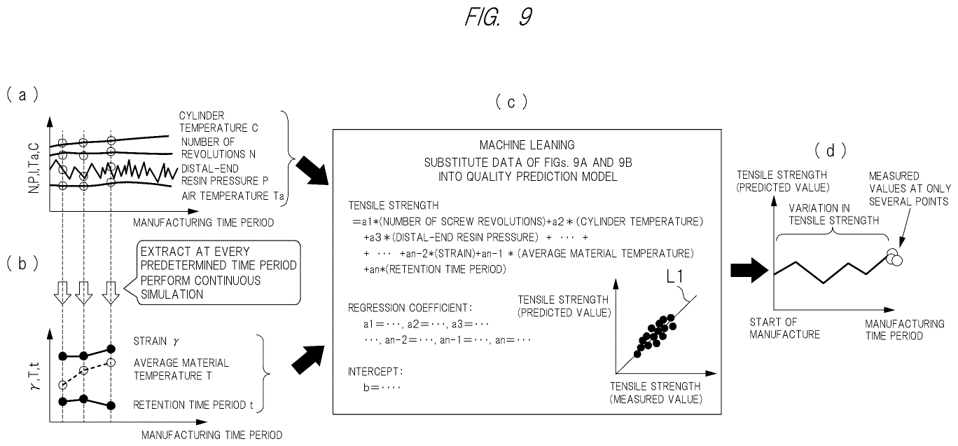

Next, an entire length quality prediction technique using the created quality prediction model 203C for predicting quality property of the heat-resistant insulated electric wire EW over its entire length will be described. FIG. 8 is a flowchart illustrating an example of a processing for achieving the entire length quality prediction technique. This processing is achieved when a quality prediction program 202B stored in the hard disk device 112 is loaded and executed by the CPU 101. FIG. 9 is a diagram for describing the entire length quality prediction technique.

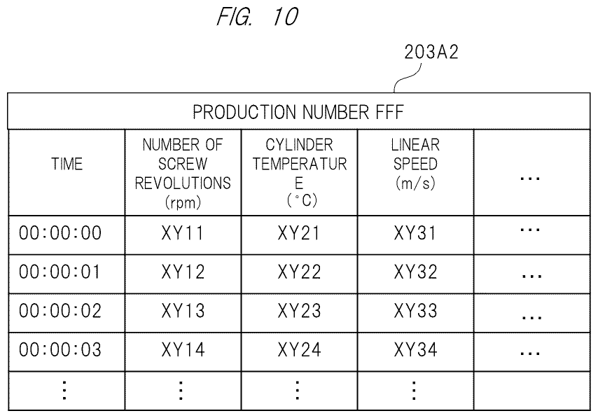

As illustrated in FIG. 8, the CPU 101 acquires second logging data in step ST201. A function of the second logging data acquisition unit 307 in the quality prediction system 100 is achieved by processing in step ST201. And, for example, at the time of manufacture of the heat-resistant resistant insulated electric wire EW, the second logging data acquisition unit 307 acquires second logging data 203A2 (see FIG. 10) during manufacture of the heat-resistant insulated electric wire EW as a prediction target.

FIG. 10 is a diagram illustrating an example of the second logging data 203A2. FIG. 10 illustrates the second logging data 203A2 for a heat-resistant insulated electric wire EW with a production number “FFF”. Factors such as a number of screw revolutions (rpm), a cylinder temperature (° C.), a linear speed (m/s), etc., are corresponded to a time. Although not illustrated, temperatures respectively acquired by the temperature sensors S21 to S25 are included as the factors in the cylinder temperature. In the present embodiment, during the manufacture of the heat-resistant insulated electric wire EW with the production number FFF, the second logging data 203A2 is included and stored in the logging data 203A of the file group 203 at every one second as the predetermined interval. Accordingly, the second logging data 203A2 is acquired from the file group 203. The illustration shows an example in which the three factors are included as the second logging data 203A2. However, the second logging data 203A2 is the logging data as a predetermined factor among all logging data as the factors that can be acquired by the quality prediction system 100, and is, for example, logging data as the same factor with that of the first logging data 203A1 used for the creation of the quality prediction model 203C.

Next, the CPU 101 performs a continuous simulation at every predetermined time period in step ST202. A function of the second simulation unit 308 in the quality prediction system 100 is achieved by processing in step ST202. The second simulation unit 308 creates the second simulation data by performing a simulation based on the second logging data 203A2 acquired by the second logging data acquisition unit 307.

For the second logging data 203A2 based on which the simulation is performed, the explanation will be made in a case where the CPU 101 acquires a cylinder temperature “C”, a number “N” of revolutions as a number of revolutions of a screw, a distal-end resin pressure “P” detected by the resin pressure sensor S18, and an air temperature “Ta” detected by the air temperature sensor S31, respectively, as the second logging data 203A as measured values as illustrated in items (a) and (b) of FIG. 9, although different from those in the example illustrated in FIG. 10. The CPU 101 extracts the second logging data 203A2 acquired at every predetermined time period, and performs the continuous simulation by using the extracted second logging data 203A2. Feature amounts as the simulation targets are a strain magnitude “γ”, an average material temperature “τ” of the heat-resistant insulating member as a material, and a retention time period “t” of the heat-resistant insulating member in the cylinder 33.

The second logging data 203A2 may be collected at time interval that is, for example, every one second in the present embodiment, or that is generally every one or shorter second. Accordingly, the second logging data 203A2 has an enormous data amount. Therefore, if the simulation is performed by using all the second logging data 203A2 as the analysis condition, the computational load of the CPU 101 becomes enormous. In consideration of the computational load of the CPU 101, the CPU 101 desirably extracts the second logging data 203A2 as the simulation target from among all the second logging data 203A2 while thinning out the second logging data 203A2 at every predetermined time period such as every 10 seconds or every 60 seconds. Since the second simulation data is calculated at every predetermined time period, the second simulation data as the simulation result is not single data but is treated as continuous data.

Next, the CPU 101 substitutes the second logging data 203A2 and the second simulation data into the quality prediction model 203C in step ST203. A function of the prediction unit 309 in the quality prediction system 100 is achieved by processing in step ST203. The prediction unit 309 predicts the quality property of the heat-resistant insulated electric wire EW as the prediction target by substituting the second logging data 203A2 and the second simulation data created by the second simulation unit 308 into the quality prediction model 203C.

For example, as illustrated in an item (c) of FIG. 9, the CPU 101 performs the machine learning by substituting the second logging data 203A2 acquired at every predetermined time period and the second simulation data acquired at every predetermined time period into the quality prediction model 203C. Here, the sophisticated AI can also be used for the machine learning. However, if the above-described python library “scikit-learn” or the like is used, the CPU 101 can perform a multiple regression analysis relatively easily. By the multiple regression analysis, each regression coefficient “a1”, “a2”, . . . for variable and an intercept “b” are acquired. The item (c) of FIG. 9 illustrates an example in which a relationship between the tensile strength (predicted value) and the tensile strength (measured value) is acquired. In this example, the predicted value and the measured value are gathered in the vicinity of a straight line L1. Accordingly, the CPU 101 determines that the quality prediction model 203C is valid.

Next, in step ST204, the CPU 101 substitutes the data acquired in step ST203 into the logging data 203A stored in the file group 203. That is, if the quality prediction model 203C is valid, the CPU 101 substitutes the acquired data such as the tensile strength (predicted value) illustrated in the item (c) of FIG. 9 into the original logging data 203A. As a result, as illustrated in an item (d) of FIG. 9, into the file group 203, the CPU 101 can store the magnitude of the tensile strength that has been acquired only around the end of the manufacturing time period, i.e., at several points of the end portion of the heat-resistant insulated electric wire EW as the measured values as the logging data 203A, instead of the magnitude of the tensile strength from the start to the end of the manufacture. As a result, the quality prediction system 100 can predict a variation in value of the quality property for the set objective variable such as the tensile strength over the entire length of the heat-resistant insulated electric wire EW.

Further, the CPU 101 may acquire the objective variable, i.e., the predicted value of the quality property nearly in real time during the manufacture of the heat-resistant insulated electric wire EW. When this result is displayed on a display device such as the display 104, an operator can always monitor the variation in the predicted value of the quality property of the heat-resistant insulated electric wire EW. In further application of this system, for example, if the predicted value of the quality property tends to exceed a proper range during the manufacture of the heat-resistant insulated electric wire EW, the CPU 101 can change manufacturing parameters such that the predicted value of the quality property tends to be the proper range. That is, the CPU 101 can properly control the manufacturing parameters.

### EXAMPLE

Next, as an example, a processing in the case of the entire length quality prediction of the heat-resistant insulated electric wire EW manufactured by the manufacturing system 1 will be described in more detail. In this example, the quality properties to be predicted are assumed to be the tensile strength and the tensile elongation defined in JIS C3005.

First, logging data used in this example will be described. The quality prediction system 100 always stores 13 values of the number of screw revolutions in the cylinder 33, the current value rotating the screw, the acceleration of the screw, the respective cylinder temperatures at five different positions, the neck temperature, the head temperature, the die temperature, the resin temperature, and the distal-end resin pressure value at every interval of one second. The 13 data values are stored as the logging data 203A in the file group 203 of the hard disk device 112.

Also, the quality prediction system 100 stores seven values in total, i.e., the air temperature of the extruder 10, the humidity of the extruder 10, the core wire temperature of the core wire CW, the water temperature of the water reservoir 40, the outer diameter size of the heat-resistant insulated electric wire EW, and the winding speed and the winding current value of the winder 50 at every interval of one second. These seven data values are stored as the logging data 203A in the file group 203 of the hard disk device 112.

In this example, in order to consider that the heat-resistant insulating member (resin) changes in its properties when being rapidly or slowly cooled, the quality prediction system 100 also stores two values, i.e., a value [“resin temperature”−“air temperature”] acquired by subtracting the air temperature from the resin temperature detected by the resin temperature sensor S17 and a value [“resin temperature”−“water temperature”] acquired by subtracting the water temperature from the resin temperature at every interval of one second. These two data values are stored as the logging data 203A in the file group 203 of the hard disk device 112. As described above, in this example, the CPU 101 uses the data of the 22 factors as the first logging data 203A1.

Next, the CPU 101 performs a simulation as illustrated in FIG. 11. FIG. 11 is a diagram for describing the outline of the simulation. As illustrated in FIG. 11, the CPU 101 performs the simulation by using screw structure information D1 representing a structure of the screw included in the cylinder 33, a number of screw revolutions D2, a resin pressure value D3, respective cylinder temperatures D4 of the temperature sensors S21 to S25, and an air temperature D5 as the analysis conditions. Simulation software used in this example is “Single Screw Simulator” manufactured by a HASL company. In this example, the seven factors, i.e., the “discharge volume”, the “maximum resin pressure”, the “driving force”, the “retention time period”, the “average temperature”, the “strain”, and the “torque” are simulated. The “maximum resin pressure”, the “driving force”, the “retention time period”, the “average temperature”, the “strain”, and the “torque” are respectively feature amounts for the heat-resistant insulating member and the screw in the cylinder 33. By the CPU 101, the seven first simulation data D11, i.e., the “discharge volume”, the “maximum resin pressure”, the “driving force”, the “retention time period”, the “average temperature”, the “strain”, and the “torque”, which are respectively simulation results, are stored as the simulation data 203B in the file group 203 of the hard disk device 112.

As described above, the CPU 101 creates the quality prediction model 203C for calculating the value of the tensile strength and the value of the tensile elongation, respectively, as the objective variables by using 29 variables including the 22 first logging data 203A1 and the seven first simulation data D11, respectively, as the explanatory variables.

In this example, 58 production numbers are prepared as a learning model, and are analyzed by performing a “multiple regression analysis” using a class “sklearn. linear_model. Linear Regression” of the python machine leaning library “scikit-learn” to calculate respective regression coefficients “a1” to “a29” of the explanatory variables and the intercept “b” (see the item (c) of FIG. 9).

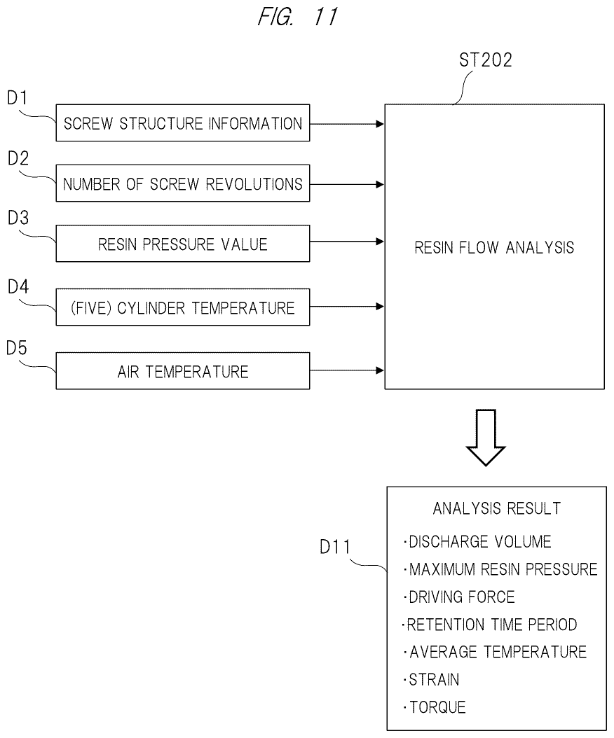

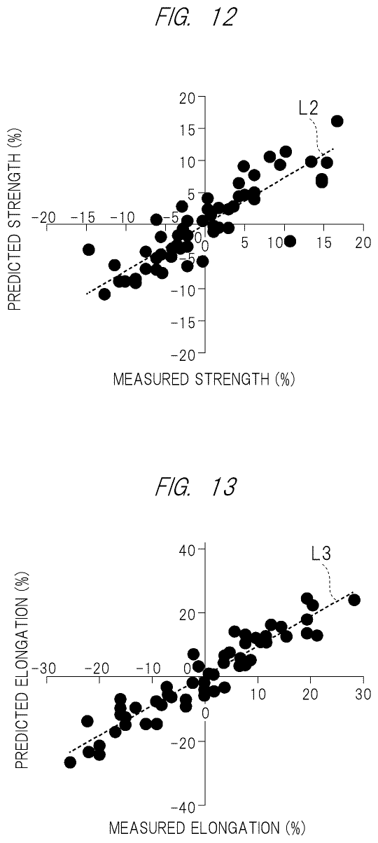

FIG. 12 is a diagram illustrating a relationship between a measured value (measured strength) and a predicted value (predicted strength) of the created tensile strength. FIG. 13 is a diagram illustrating a relationship between a measured value (measured elongation) and a predicted value (predicted elongation) of the created tensile elongation. In FIG. 12, an average value of the tensile strength is set to zero, and a tensile strength higher than the average value is illustrated with “+”, and a tensile strength lower than the average value is illustrated with “−”. The same applies to the tensile elongation illustrated in FIG. 13. As illustrated in FIG. 12, there is a substantially constant relationship between the measured strength and the predicted value. As a result, the CPU 101 created the quality prediction model 203C for the tensile strength as illustrated with a dashed line L2. A determination coefficient as a gradient of the dashed line L2 is 0.79, and an intercept is 0. As illustrated in FIG. 13, there is a substantially constant relationship between the measured elongation and the predicted elongation. As a result, the CPU 101 created the quality prediction model 203C for the tensile elongation as illustrated with a dashed line L3. A determination coefficient as a gradient of the dashed line L2 is 0.89, and an intercept is 0.

Next, the CPU 101 performs the entire length prediction of the heat-resistant insulated electric wire EW as the prediction target manufactured by the manufacturing system 1 by using the quality prediction models 203C for the tensile strength and the tensile elongation respectively illustrated in FIGS. 12 and 13.

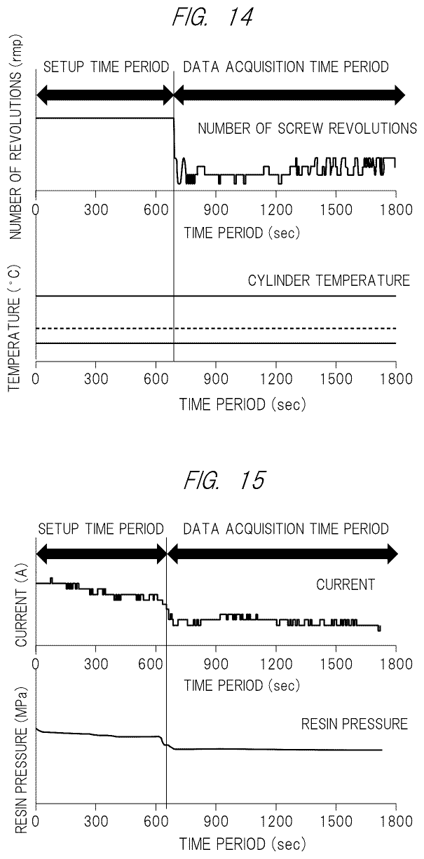

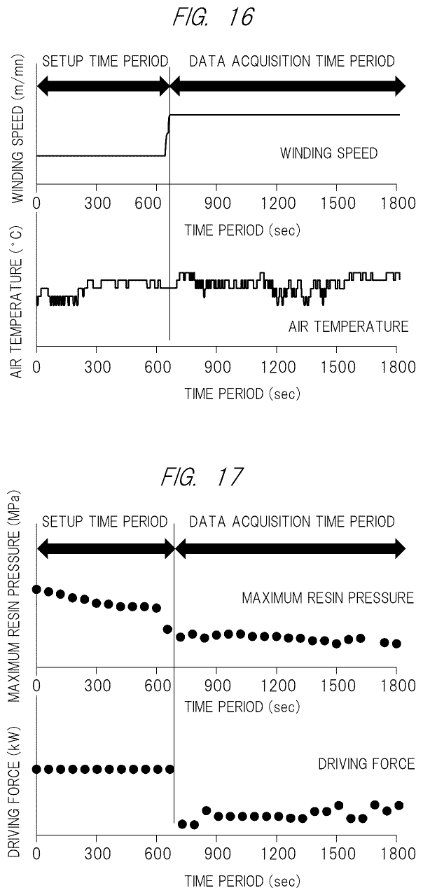

FIGS. 14 to 16 are diagrams each illustrating an example of the second logging data 203A2 acquired at every interval of one second. FIG. 14 is a diagram illustrating the number of screw revolutions and the cylinder temperature as the second logging data 203A2. As the cylinder temperature, all temperatures to be respectively detected by the temperature sensors S21 to S25 may be acquired, or any temperature may be acquired. For example, the CPU 101 acquires three temperatures to be respectively detected by the temperature sensors S23, S24, and S25 close to the head 31. FIG. 15 is a diagram illustrating the current value of the cylinder 33 and the resin pressure value detected by the resin pressure sensor S18 as the second logging data 203A2. FIG. 16 is a diagram illustrating the winding speed of the winder 50 and the ambient air temperature as the second logging data 203A2. The CPU 101 extracts the second logging data 203A2 among the second logging data 203A2 respectively illustrated in FIGS. 14 to 16, at every 60 seconds.

Next, the CPU 101 performs a simulation by using the extracted second logging data 203A2. The CPU 101 performs a simulation from the setup time period to be normally excluded, in order to evaluate the validity of the simulation result. Here, the setup time period described here is a time period before the actual start of the manufacture of the heat-resistant insulated electric wire EW.

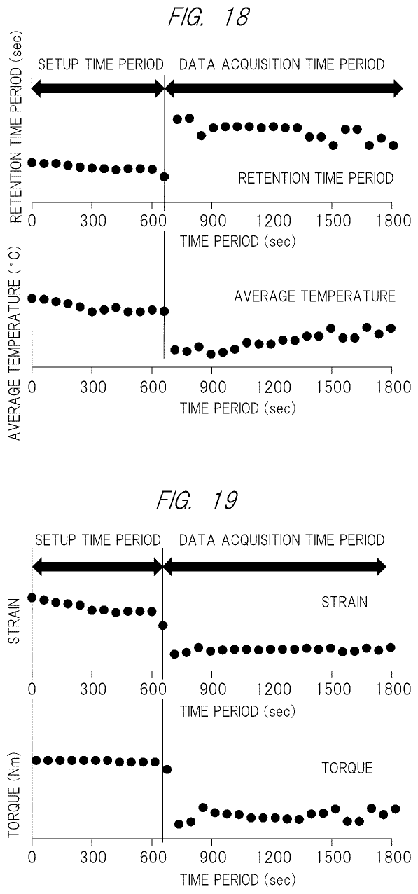

FIGS. 17 to 19 are diagrams each illustrating one example of the second simulation data representing the simulation result. FIG. 17 is a diagram illustrating the maximum resin pressure and the driving force as the second simulation data. FIG. 18 is a diagram illustrating the retention time period and the average temperature as the second simulation data. FIG. 19 is a diagram illustrating the strain and the torque as the second simulation data. As illustrated in FIGS. 17 to 19, it is found that a tendency of continuity of data greatly changes between the setup time period and the data acquisition time period. Accordingly, the CPU 101 can determine that the simulation result is valid.

Next, the CPU 101 substitutes the second logging data 203A2 extracted at every 60 seconds from among the second logging data illustrated in FIGS. 14 to 16 and the second simulation data at every 60 seconds illustrated in FIGS. 17 to 19 into the quality prediction models 203C for the tensile strength and the tensile elongation respectively illustrated in FIGS. 12 and 13. As a result, the CPU 101 can calculate respective predicted values of the tensile strength and the tensile elongation at every 60 seconds over the entire length of the heat-resistant insulated electric wire EW. Therefore, the CPU 101 can predict the tensile strength and the tensile elongation of the manufactured heat-resistant insulated electric wire EW, in other words, the quality property over the entire length of the heat-resistant insulated electric wire EW. The predicted values of the tensile strength and the tensile elongation are stored as part of the logging data 203A in the file group 203 of the hard disk device 112 so as to be included in the logging data 203A acquired in step ST201.

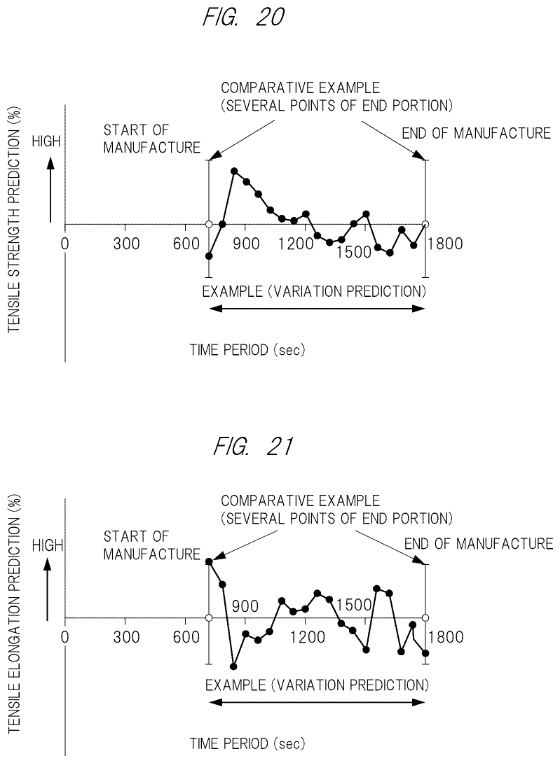

FIG. 20 is a diagram illustrating the prediction result of the tensile strength of the heat-resistant insulated electric wire EW. FIG. 21 is a diagram illustrating the prediction result of the tensile elongation of the heat-resistant insulated electric wire EW. As illustrated in FIGS. 20 and 21, a state of the changes in the respective predicted values of the tensile strength and the tensile elongation is acquired from the start to the end of the manufacture of the heat-resistant insulated electric wire EW, that is, over the entire length of the heat-resistant insulated electric wire EW. On the other hand, in a comparative example not using the technique of this example, the respective values of the tensile strength and the tensile elongation can be acquired only at several points of the end portion of the heat-resistant insulated electric wire EW. Therefore, the quality prediction system 100 in this example can predict the tensile strength and the tensile elongation over the entire length of the heat-resistant insulated electric wire EW. Accordingly, the quality prediction system 100 can acquire a state of variations in the quality properties over the entire length of the heat-resistant insulated electric wire EW.

The quality prediction system 100 needs to create the quality prediction model 203C from the logging data of the elongated product manufactured in past, that is, the already-known first logging data 203A1. Accordingly, if the elongated product has been manufactured in past, the technique of the quality prediction system 100 can be applied to this elongated product. Particularly, for the elongated product having a sufficient manufacturing track record, the accuracy of the predicted value can be enhanced. Accordingly, the quality prediction system 100 can greatly improve the effectiveness of the prediction of the quality property.

Further, the quality prediction system 100 can predict the quality properties of the elongated product, which are not only the tensile strength and the tensile elongation of the elongated product but also those such as the flame retardancy and the oil resistance allowed to be evaluated only by the destructive test for the end portion.

As described above, the quality prediction system 100 creates the quality prediction model 203C by using not only the already-known first logging data 203A1 but also the first simulation data based on the already-known first logging data 203A1. The quality prediction system 100 predicts the quality property of the elongated product by using not only the second logging data 203A2 during manufacture but also the second simulation data based on the second logging data 203A2 during manufacture and the quality prediction model 203C. However, the processing for the quality prediction model creation and the quality prediction performed by the quality prediction system 100 are not limited to them. For example, the quality prediction system 100 may create a quality prediction model based on only the already-known first logging data 203A1. The quality prediction system 100 may predict the quality property of the elongated product by using a quality prediction model created based on only the second logging data 203A2 during manufacture and the already-known first logging data 203A1. This results in a reduced processing load of the quality prediction system 100.

In the foregoing, the invention made by the present inventors of the present application has been concretely described on the basis of the embodiments. However, it is needless to say that the present invention is not limited to the foregoing embodiments, and various modifications can be made within the scope of the present invention.

What is claimed is:

1. A quality prediction model creation system comprising:
a first logging data acquisition unit acquiring already-known first logging data respectively detected at every predetermined interval by a plurality of detectors and stored at time of manufacture of an elongated product;
an average value calculation unit calculating each average value of the first logging data from the first logging data acquired by the first logging data acquisition unit; and
a model creation unit creating a quality prediction model corresponded to quality property of the elongated product, based on the average value of the first logging data.

2. The quality prediction model creation system according to claim 1, further comprising
a first simulation unit simulating the quality property of the elongated product by using the average value of the first logging data,
wherein the model creation unit creates the quality prediction model, based on the average value of the first logging data and first simulation data representing a result of the simulation.

3. The quality prediction model creation system according to claim 2, further comprising
a data merging unit acquiring quality result data of a quality test performed for an end portion of the elongated product, and merging the quality result data with the first simulation data,
wherein, when the quality prediction model is created, the model creation unit uses a result of the merging made by the data merging unit.

4. The quality prediction model creation system according to claim 2,
wherein the model creation unit creates the quality prediction model by using machine learning while setting quality property data representing the quality property of the elongated product as an objective variable, and setting the first logging data of the elongated product and the first simulation data as an explanatory variable.

5. The quality prediction model creation system according to claim 4,
wherein the elongated product is an electric wire covered with a heat-resistant insulating member,
the electric wire is manufactured by an extruder including a cylinder including a screw and a winder winding the electric wire, and
the explanatory variable includes at least one or more of a number of screw revolutions of the screw, a cylinder temperature of the cylinder, a linear speed of the winding of the electric wire by the winder, a retention time period of the heat-resistant insulating member in the cylinder, a pressure value of the heat-resistant insulating member, and a value of a strain of the heat-resistant insulating member.

6. The quality prediction model creation system according to claim 4,
wherein the elongated product is an electric wire covered with a heat-resistant insulating member, and
the objective variable includes a value of a tensile strength or a value of a tensile elongation of the electric wire.

7. A quality prediction system comprising:
a quality prediction model storage unit storing a quality prediction model, created based on an average value of already-known first logging data of an elongated product and corresponded to quality property of the elongated product;
a second logging data acquisition unit acquiring second logging data during manufacture of an elongated product as a prediction target; and
a prediction unit predicting quality property of the elongated product as the prediction target by substituting the second logging data acquired by the second logging data acquisition unit into the quality prediction model.

8. The quality prediction system according to claim 7, further comprising
a second simulation unit creating second simulation data by performing a simulation based on the second logging data acquired by the second logging data acquisition unit,
wherein the prediction unit predicts the quality property of the elongated product as the prediction target by substituting the second logging data acquired by the second logging data acquisition unit and the second simulation data created by the second simulation unit into the quality prediction model.

9. The quality prediction system according to claim 8,
wherein the second simulation unit performs the simulation based on logging data extracted at every predetermined interval from the second logging data acquired by the second logging data acquisition unit.

10. The quality prediction system according to claim 7,
wherein the prediction unit stores quality property data representing the quality property together with the second logging data acquired by the second logging data acquisition unit.

11. A quality prediction model creation method comprising steps of:
acquiring already-known first logging data respectively detected at every predetermined interval by a plurality of detectors and stored at time of manufacture of an elongated product;
calculating each average value of the first logging data from the acquired first logging data; and
creating a quality prediction model corresponded to quality property of the elongated product, based on the average value of the first logging data.

12. The quality prediction model creation method according to claim 11, further comprising steps of:
calculating each average value of the first logging data, and then, simulating the quality property of the elongated product by using the average value of the first logging data; and
creating the quality prediction model, based on the average value of the first logging data and first simulation data representing a result of the simulation.

13. A quality prediction method comprising steps of:
acquiring already-known first logging data respectively detected at every predetermined interval by a plurality of detectors and stored at time of manufacture of an elongated product;
calculating each average value of the first logging data from the acquired first logging data;
creating a quality prediction model corresponded to quality property of the elongated product, based on the average value of the first logging data;
acquiring second logging data during manufacture of an elongated product as a prediction target; and
predicting quality property of the elongated product as the prediction target by substituting the second logging data into the quality prediction model.

14. The quality prediction method according to claim 13,
wherein the quality prediction model is created by the first logging data and first simulation data acquired based on the first logging data,
the method further comprising steps of:
acquiring the second logging data, and then, creating second simulation data by performing a simulation based on the second logging data; and
substituting the second logging data and the second simulation data into the quality prediction model.
